(19) United States
(12) Patent Application Publication
(10) Pub. No.: US 2018/0039196 A1
(43) Pub. Date: Feb. 8, 2018

(54) TONER FOR ELECTROSTATIC CHARGE IMAGE DEVELOPMENT

(71) Applicant: Mitsubishi Chemical Corporation, Chiyoda-ku (JP)

(72) Inventors: Takeshi OWADA, Niigata (JP); Masaaki OKAMOTO, Niigata (JP)

(73) Assignee: Mitsubishi Chemical Corporation, Chiyoda-ku (JP)

(21) Appl. No.: 15/710,973

(22) Filed: Sep. 21, 2017

Related U.S. Application Data
(63) Continuation of application No. PCT/JP2016/059245, filed on Mar. 23, 2016.

(30) Foreign Application Priority Data
Mar. 24, 2015 (JP) 2015-061264

(51) Int. Cl. G03G 9/097

(52) U.S. Cl. CPC G03G 9/09725

(57) ABSTRACT

An object of the present invention is to provide a toner being free of a problem of image non-uniformity or carrier attraction due to charging unevenness and enabling stable printing, even at continuous printing, in a high-speed development system susceptible to stress. In the toner for developing an electrostatic charge image of the present invention, as an external additive of the toner, a metal oxide-polymer composite particle containing a polymer-grafted metal oxide, and a composite oxide particle having a core-shell structure, with the core part containing titania and the shell part containing silica, are added as a first external additive and a second external additive, respectively.

### TECHNICAL FIELD

The present invention relates to a toner for developing an electrostatic charge image used for electrophotography, xerography, etc.

### BACKGROUND ART

The electrophotography generally includes steps of forming an electrostatic latent image on a photoconductive photoreceptor by various methods; subsequently making the latent image visible by using a toner for developing an electrostatic image (hereinafter, simply referred to as “toner”); thereafter transferring the visible toner image onto a transfer material such as paper, and fixing the toner image by heating, pressing, etc. As for these steps, various methods are known, and a method suitable for each image forming process is employed.

As one of representative toner production methods, a pulverization method of melting/mixing a variety of materials such as binder resin, coloring agent and charge control agent, and forming a fine powder through pulverization-classification is known and since a high-quality toner is obtained relatively in a simple and easy manner, this method is widely employed in general irrespective of various color or monochromatic development systems. In recent years, higher-speed process and higher image quality are required of electrophotography, and in order to respond to this requirement, studies and developments are being aggressively made on a polymerized toner. The particle diameter of a polymerized toner can be easily controlled in comparison with a pulverized toner, and a toner mother particle having a small particle diameter which is suitable for the realization of high image quality can thereby be obtained.

Furthermore, the toner can be encapsulated by controlling the particle structure and is therefore advantageous in that a toner excellent in the heat resistance or low-temperature fixing property is obtained. In addition, the polymerized toner has a relatively round shape, relieving the stress acting thereon at the time of continuous actual printing, and it is therefore relatively easy to respond to a high process speed and a long press life required of a large copying machine or printer, among others.

Considering these properties of the polymerized toner, various studies are being made to stably achieve high image quality in a high-speed process susceptible to stress. In particular, a technique of obtaining a spacer effect by externally adding an inorganic/organic fine powder having a relatively large particle diameter is known.

For example, Patent Document 1 has reported to obtain a spacer effect by mixing a monodisperse spherical silica of 80 to 300 nm. Patent Document 2 has reported to obtain a spacer effect by attaching, to the toner surface, an inorganic fine particle having a number average particle diameter of 30 to 300 nm and an organic fine particulate matter having a number average particle diameter of 50 to 1,000 nm at a specific isolation rate. In addition, Patent Document 3 has reported to disperse a composite particle of a metal oxide and a polymer on the toner surface and thereby prevent separation of an external additive providing a spacer effect.

### BACKGROUND ART LITERATURE

### Patent Document

Patent Document 1: JP-A-2001-066820
Patent Document 2: JP-A-2010-039264
Patent Document 3: JP-A-2013-92748

### SUMMARY OF THE INVENTION

### Problems that the Invention is to Solve

However, as a result of studies by the present inventors, it has been revealed that in the technique of Patent Document 1, the monodisperse spherical silica tends to roll on the toner surface when it is exposed to stress from the developing machine due to stirring, etc. at the time of continuous printing and accumulate in a concave part on the surface, failing in providing a sufficient spacer effect throughout continuous printing. The toner charge amount is thereby rendered non-uniform, as a result, particularly, generation of a high-charge toner particle causes unevenness in the printed image and in the case of a two-component development system using a carrier, brings about so-called “carrier attraction” of letting the carrier adhering to the high-charge particle by a strong image force be disengaged from the magnetic development roller and developed together with the toner on the photoreceptor.

In addition, it has been revealed that in the technique of Patent Document 2, the organic fine particulate matter is detached from the toner when it is exposed to stress from the developing machine at the time of continuous printing and a sufficient spacer effect throughout continuous printing is not obtained.

Furthermore, it has been revealed that in the technique of Patent Document 3, when the composite particle is dispersed on the surface, the toner charge amount is rendered non-uniform and a low-charge toner particle is generated to cause contamination of the non-printed part with toner after printing, so-called fogging, and in turn deteriorate the print quality.

As described above, the techniques for providing a toner being free of a problem of carrier attraction or fogging due to charging unevenness and enabling stable printing, even at continuous printing, in a high-speed development system susceptible to stress are still insufficient, and the present invention has been made by taking into account these background techniques.

### Means for Solving the Problems

As a result of many intensive studies to solve the problems above, the present inventors have found that those problems can be solved by forming a toner including a composite particle of a metal oxide having a specific structure and a polymer, and a composite oxide particle having a specific structure. Namely, the gist of the present invention resides in the following [1] to 151.

[1] A toner for developing an electrostatic charge image having a toner mother particle containing a binder resin and a coloring agent, and an external additive, wherein:

the external additive contains, as a first external additive, a metal oxide-polymer composite particle containing a metal oxide binding to a polymer and, as a second external additive, a composite oxide particle containing titania and silica.

[2] The toner for developing an electrostatic charge image according to the above [1], wherein SF2 represented by the following formula (2) of the toner is from 100 to 120:

SF2=(T²/S)×(1/4π)×100 Formula (2):

(in formula (2), S represents the particle projected area, and T represents the circumferential length of a particle projection image).
[3] The toner for developing an electrostatic charge image according to the above [1] or [2], wherein the metal oxide of the metal oxide-polymer composite particle is silicon oxide.
[4] The toner for developing an electrostatic charge image according to any one of the above [1] to [3], wherein the value A=(weight of metal oxide/weight of polymer)(true specific gravity of metal oxide: g/cm³) as determined by ash measurement of the metal oxide-polymer composite particle in a calorimeter measuring device is from 0.5 to 2.5.
[5] The toner for developing an electrostatic charge image according to any one of the above [1] to [4], wherein a compound having a skeleton represented by the following formula (1) is detected by pyrolysis gas chromatography-mass spectrometry on the metal oxide-polymer composite particle:

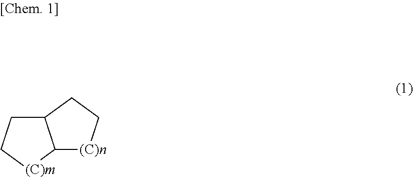

(in formula (1), each of m and n independently represents an integer of 1 to 3).

### Effect of the Invention

According to the present invention, a toner which is free of a problem of image non-uniformity or carrier attraction due to charging unevenness and enables stable printing, even at continuous printing, in a high-speed development system susceptible to stress can be provided by forming a toner including, as external additives, a composite particle of a metal oxide having a specific structure and a polymer, and a composite oxide particle having a specific structure.

### MODE FOR CARRYING OUT THE INVENTION

Although the present invention is described in detail below, the present invention is not limited to the following embodiment and can be implemented by making arbitrary modifications without departing from the gist of the present invention.

In the present Description, all percentages or parts by mass are the same as the percentages or parts by weight.

### <Configuration of Toner of the Present Invention>

The toner of the present invention has an external additive and is characterized in that the external additive contains, as a first external additive, a metal oxide-polymer composite particle containing a metal oxide which binds to a polymer and, as a second external additive, a composite oxide particle containing titania and silica.

### <Composite Particle of Metal Oxide and Polymer>

The toner of the present invention contains, as a first external additive, a metal oxide-polymer composite particle, i.e., a polymer-grafted metal oxide, where in the composite particle, the metal oxide particle which binds to a polymer by a covalent bond, and the surface of the metal oxide is treated with a hydrophobizing agent.

The metal oxide particle used contains silica, alumina, titania, zirconia, zinc oxide, iron oxide, niobium oxide, vanadium oxide, tungsten oxide, or a mixed oxide of two or more thereof. In particular, the metal oxide particle preferably contains at least one of silica, alumina and titania.

The metal oxide particle is treated with a first hydrophobizing agent containing a group capable of binding to the polymer of the metal oxide-polymer composite particle. In the case where the metal oxide particle is silica, the hydrophobizing agent may include the formula: Si[H_{3-X}(OR¹)_{X}]R²Q (wherein X is 1, 2 or 3, R¹ is a methyl group or an ethyl group, R² is an alkyl linker of the formula: CₙH₂ₙ (wherein n is 1 to 10), and Q is a substituted or unsubstituted vinyl group, an acrylate group or a methacrylate group). Examples of the first hydrophobizing agent which is preferably used include vinyltriacetoxysilane, (3-acryloxypropyl)trimethoxysilane, (3-acryloxypropyl)triethoxysilane, methacryloxypropyltrimethoxysilane, methacryloxypropyltriethoxysilane, (3-acryloxypropyl)methyldimethoxysilane, methacryloxypropylmethyldimethoxysilane, methacryloxypropyldimethylethoxysilane, methacryloxypropyldimethylmethoxysilane, allyltrimethoxysilane, vinyltriethoxysilane, vinyltrimethoxysilane, and vinyltris(2-methoxyethoxy)silane. In the case where the metal oxide is not silica, a di- or tri-functional silane is preferably used.

The polymer used may be the same as or different from the first hydrophobizing agent. Specifically, in the case where the first hydrophobizing agent contains a polymerizable group, the same material may be used simply and easily for forming the polymer. In addition, a different monomer copolymerizable with a terminal group of the first hydrophobizing agent may be used. The monomer preferably used for producing the metal oxide-polymer composite particle contains substituted or unsubstituted vinyl and acrylate monomers, and another monomer polymerizable by radical polymerization. Typical monomers include styrene acrylate, styrene methacrylate, olefin, vinyl ester, and acrylonitrile. These monomers may be used individually or as a mixture by forming a copolymer or may be used together with a crosslinking agent.

Among composite particles, a composite particle containing a compound having a skeleton represented by the following formula (1), which is detected by pyrolysis gas chromatography-mass spectrometry for the composite particle, is most preferred in view of spacer effect and chargeability.

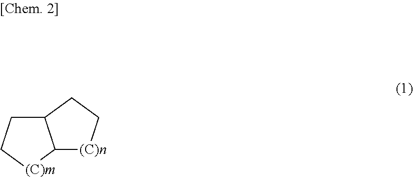

(in formula (1), each of m and n independently represents an integer of 1 to 3).

As to the conditions of pyrolysis gas chromatography-mass spectrometry, for example, the conditions described in Examples may be applied. In addition, such a composite particle can be obtained by the method described, for example, in JP-A-2013-92748.

The value A=(weight of metal oxide/weight of polymer)/(true specific gravity of metal oxide: g/cm³) as determined by ash measurement of the composite particle is preferably from 0.5 to 2.5, and from the viewpoint that the composite particle functions more suitably as a spacer, is more preferably from 0.75 to 2.0.

If the value A is smaller than 0.5, i.e., the proportion of the polymer is too large, the composite particle may readily detach from the toner. On the other hand, if the value exceeds 2.5, i.e., the proportion of the metal oxide is too large, the chargeability of the toner may be likely to be governed by the chargeability of the metal oxide to produce unevenness in the charge amount.

The true specific gravity of metal oxide and the weight ratio of metal oxide and polymer in the formula for obtaining the value A can be determined by the methods described in Examples.

Although the addition amount of the composite particle per 100 parts by mass of the toner mother particle is not particularly limited as long as the effects of the present invention are not significantly impaired, the lower limit is usually 0.3 parts by mass or more, preferably 0.5 parts by mass or more, and more preferably 1.0 parts by mass or more. On the other hand, the upper limit is usually 10 parts by mass or less, preferably 8 parts by mass or less, and more preferably 5 parts by mass or less. If the addition amount of the composite oxide particle is too small, a sufficient spacer effect may not be obtained, leading to occurrence of fogging in continuous actual printing or deterioration of the image uniformity. On the other hand, if the addition amount is too large, the toner charge amount may be reduced to impair the print quality.

### <Composite Oxide Particle>

The external additive used in the present invention contains a titania-silica composite oxide particle as a second external additive. The titania-silica composite oxide particle has a core-shell structure, and the core part and the shell part contain titania and silica, respectively.

Although the content of silica in the composite oxide particle is not particularly limited as long as the effects of the present invention are not significantly impaired, but the lower limit is usually 6% by mass or more, preferably 8% by mass or more and more preferably 10% by mass or more. On the other hand, the upper limit is usually 20% by mass or less, preferably 18% by mass or less, more preferably 16% by mass or less. If the content of silica in the composite oxide particle is too small, the required charge amount may not be obtained, leading to occurrence of fogging or reduction in the solid followability. In addition, the flowability may also be deteriorated to cause reduction in the solid image followability as well. On the other hand, if the content of silica in the composite oxide particle is too large, deterioration of the cleaning property or reduction in the charging rise may be caused due to excessive flowability, and the charging of toner may not catch up with rotation of the development roller or supply roller, giving rise to fogging and solid image followability failure.

Although the average primary particle diameter of the composite oxide particle is not particularly limited as long as the effects of the present invention are not significantly impaired, the lower limit is usually 10 nm or more, preferably 12 nm or more, and more preferably 14 nm or more. On the other hand, the upper limit is usually 24 am or less, preferably 22 nm or less, and more preferably 20 nm or less. If the average primary particle diameter of the composite oxide particle is too small, excessive embedment in the toner mother particle may occur to deteriorate the flowability in the latter half of printing and generate blur, etc. On the other hand, if the average primary particle diameter is too large, the flowability-imparting effect may be small to deteriorate the solid image followability, or it may be difficult for the particle to adhere to the toner mother particle, causing contamination of a member due to detachment.

Although the addition amount of the composite oxide particle per 100 parts by mass of the toner mother particle is not particularly limited as long as the effects of the present invention are not significantly impaired, the lower limit is usually 0.3 parts by mass or more, preferably 0.45 parts by mass or more, and more preferably 0.6 parts by mass or more. On the other hand, the upper limit is usually 1.4 parts by mass or less, preferably 1.3 parts by mass or less, and more preferably 1.2 parts by mass or less. If the addition amount of the composite oxide particle is too small, sufficient charge rising property or flowability may not be obtained, and fogging or blur of a solid image may be caused due to an insufficiently charged toner. On the other hand, if the addition amount is too large, the toner charge amount distribution may be broadened to decrease the transfer efficiency and increase the toner consumption.

The composite oxide particle used in the present invention is not particularly limited in its production method and can be formed by a known method. For example, the composite oxide particle is produced by the methods described in JP-A-8-253321, JP-T-2006-511638, JP-A-2006-306651, and WO. 2009/084184.

### <Other External Additives>

In the toner of the present invention, other than the above-described external additives, one of generally well-known external additives for toner may be used, or a plurality of those external additives may be used in combination. Examples of the external additive include, as an inorganic particle, titania, aluminum oxide (alumina), zinc oxide, tin oxide, barium titanate, strontium titanate, and hydrotalcite, and include, as an organic particle, an organic acid salt particle such as zinc stearate and calcium stearate, and an organic resin particle such as methacrylic acid ester polymer particle, acrylic acid ester polymer particle, styrene-methacrylic acid ester copolymer particle and styrene-acrylic acid ester copolymer particle.

The charge level or flowability of the toner can be controlled by combining these additives in appropriate amounts and externally adding them with appropriate strength.

### <Other Configurations and Production Method of Toner Mother Particle>

The volume median diameter of the toner mother particle of the present invention is not particularly limited but is usually 3 μm or more, preferably 4 μm or more, and still more preferably 5 μm or more, and is usually 10 μm or less, 8 μm or less and more preferably 7 μm or less. If the volume median diameter of the toner is too large, the charge amount per unit weight may become small, leading to an increased possibility of occurrence of fogging or toner scattering, while if the volume median diameter is too small, the charge amount per unit weight may readily become excessive, making it likely to cause a problem such as extreme reduction in image density. The volume median diameter can be measured by the method described in Examples.

The toner mother particle of the present invention is most effective when the shape thereof is spherical. Specifically, its effect is maximally shown when the shape factor SF2 of the toner, represented by the following formula (2), is 120 or less.

SF2=(T²/S)×(1/4π)×100 Formula (2):

In formula (2), S represents the particle projected area, and T represents the circumferential length of a particle projection image.

If SF2 exceeds 120, i.e., if the toner mother particle is in a complicated shape having many recesses and protrusions on the surface, the external additive is buried in the recess part on the toner mother particle surface and does not emerges on the toner surface, and the effect due to this formulation of external additives may be less likely to be brought out. In the present invention, the lower limit of SF2 is not particularly limited but is preferably 100 or more.

The SF2 can be measured by the method described in Examples.

Although the toner of the present invention is not particularly limited in its constitutional material, it contains at least a binder resin and a coloring agent and, if desired, contains a charge control agent, a wax, other additives, etc.

The production method of the toner mother particle of the present invention is not limited, and a conventionally employed method, for example, a pulverization method, a wet process, or a method of spheroidizing the toner by mechanical impact force, heat treatment, etc., may be used. The wet process includes a suspension polymerization method, an emulsion polymerization aggregation method, a dissolution suspension method, an ester extension method, and other methods.

In the pulverization method, a binder resin, a coloring agent and, if desired, other components are weighed in predetermined amounts, blended and mixed. Examples of the mixing apparatus include a double-cone mixer, a V-type mixer, a drum-type mixer, a super mixer, a Henschel mixer, and a Nauta mixer.

The toner raw material obtained by the blending and mixing those described above is melt-kneaded to melt the resins and disperse the coloring agent, etc. therein. In the melt-kneading step, for example, a batch kneader such as pressure kneader and Banbury mixer, or a continuous kneader may be used. As the kneader, a single-screw or twin-screw extruder is used, and examples thereof include a KTK-type twin-screw extruder manufactured by Kobe Steel, Ltd., a TEM-type twin-screw extruder manufactured by Toshiba Machine Co., Ltd., a twin-screw extruder manufactured by KCK, and a co-kneader manufactured by Buss. Furthermore, a colored resin composition obtained by melt-kneading the toner raw material is rolled by a twin roll, etc. after the melt-kneading, and passed through a step of cooling the rolled material by water cooling, etc. to provide a cooled product.

The cooled product obtained above of the colored resin composition is then pulverized to a desired particle diameter in a pulverization step. In the pulverization step, the cooled product is first roughly pulverized by a crusher, a hammer mill, a feather mill, etc. and further pulverized by, e.g., Kriptron System manufactured by Kawasaki Heavy Industries, Ltd. or Super Rotor manufactured by Nisshin Engineering Inc. Thereafter, if desired, the pulverized product is classified by means of a sieving machine, for example, a classification machine such as Elbow-Jet of an inertial classification system (manufactured by Nittetsu Mining Co., Ltd.) or Turboplex of a centrifugal classification system (manufactured by Hosokawa Micron Corporation), to obtain a toner mother particle. Furthermore, in order to obtain desired shape factor SF1 and shape factor SF2 of the toner particle, the toner may be spheroidized by a conventionally employed method, for example, by using a spheroidizing apparatus such as Meteorainbow and Faculty.

After obtaining the toner mother particle, the toner can be obtained through a processing step of adding external additives and, if desired, other processing steps.

The wet process includes an emulsion polymerization aggregation method, a suspension polymerization method, a dissolution suspension method, etc. The toner mother particle may be produced by any method, and the production method is not particularly limited.

In the case of producing the toner mother particle by an emulsion polymerization aggregation method, the method usually includes a polymerization step of polymerizing a polymer particle and obtaining a polymer particle dispersion liquid, a mixing step of mixing the polymer particle dispersion liquid with a coloring agent particle dispersion liquid, etc., an aggregation step of adding an aggregating agent to the mixed dispersion liquid, and aggregating the particles to a predetermined particle diameter to obtain a particle aggregate (aggregated particle), a fusion step of heating and fusing the aggregated particle to form a fused particle, and subsequently, steps for taking out the particle as a toner mother particle, such as filtration, washing and drying steps.

In the present invention, as to the production method of a suspension polymerization toner, a monomer composition in which a coloring agent, a polymerization initiator and, if desired, an additive such as wax, polar resin, charge control agent and crosslinking agent are added to the monomer of the binder resin and uniformly dissolved or dispersed, is prepared. This monomer composition is dispersed in an aqueous medium containing a dispersion stabilizer, etc., and granulation is performed preferably by adjusting the stirring speed/time so that a droplet of the monomer composition can have a desired toner particle size. Thereafter, polymerization is performed by carrying out stirring to such an extent that the particle state is maintained by the action of the dispersion stabilizer and the precipitation of particle is prevented. The particles are collected through washing and filtration and dried, and the toner mother particle can thereby be obtained. After obtaining the toner mother particle, the toner can be obtained through a processing step of adding external additives and, if desired, other processing steps.

The dissolution suspension method is a method in which a solution phase obtained by dissolving a binder resin in an organic solvent and adding and dispersing a coloring agent, etc. therein is dispersed by means of mechanical shear force in an aqueous phase containing a dispersing agent, etc. to form a droplet and the organic solvent is removed from the droplet to produce a toner particle.

The ester extension polymerization method is a method in which an oil phase having dispersed therein a wax, a polyester resin, a pigment, etc. and an aqueous phase having added thereto a particle diameter controlling agent and a surfactant are mixed and emulsified to produce oil droplets; a polymer resin component is formed on the toner oil droplet surface by an extension reaction at the same time as convergence of the oil droplet; and the solvent inside the oil droplet is removed to produce a toner particle.

In the present invention, as the binder resin contained in the toner, a resin conventionally used as a binder resin of the toner may appropriately be used.

The binder resin used in case of producing the toner mother particle by the pulverization method includes polystyrene, a homopolymer of substituted styrene, a styrene-based copolymer, acrylic acid, methacrylic acid, a polyester resin, a polyamide resin, an epoxy resin, a xylene resin, a silicone resin, etc. One of these resins may be used alone, or a mixture thereof may be used.

The binder resin used in case of producing toner mother particle by the polymerization method includes a vinyl-based polymerizable monomer capable of radical polymerization. Examples thereof include styrene, a styrene derivative, an acrylic polymerizable monomer, a methacrylic polymerizable monomer, a vinyl ester, a vinyl ether, a vinyl ketone, etc. One of these resins may be used alone, or a mixture of two or more kinds thereof may be used.

As the monomer, out of a polymerizable monomer having an acidic group (hereinafter, sometimes simply referred to as “acidic monomer”), a polymerizable monomer having a basic group (hereinafter, sometimes simply referred to as “basic monomer”), and a polymerizable monomer having neither an acidic group nor a basic group (hereinafter, sometimes referred to as “other monomers”), any polymerizable monomer may be used.

Among the above-described polymerization methods, in the case of producing the toner mother particle by using the emulsion polymerization aggregation method, in the emulsion polymerization step, a polymerizable monomer is usually polymerized in an aqueous medium in the presence of an emulsifier, and here, at the time of supplying a polymerizable monomer to the reaction system, respective monomers may be added separately, or a plurality of kinds of monomers may be preliminarily mixed and added simultaneously. In addition, the monomer may be added as it is or may be added in the form of an emulsion prepared by preliminarily mixing the monomer with water, an emulsifier, etc.

The acidic monomer includes, for example, a polymerizable monomer having a carboxyl group, such as acrylic acid, methacrylic acid, maleic acid, fumaric acid and cinnamic acid, a polymerizable monomer having a sulfonic acid group, such as sulfonated styrene, and a polymerizable monomer having a sulfonamide group, such as vinylbenzenesulfonamide. The basic monomer includes, for example, an aromatic vinyl compound having an amino group, such as aminostyrene, a polymerizable monomer containing a nitrogen-containing hetero ring, such as vinylpyridine and vinylpyrrolidone, and a (meth)acrylic acid ester having an amino group, such as dimethylaminoethyl acrylate and diethylaminoethyl methacrylate. One of these acidic monomers and basic monomers may be used alone, a plurality of kinds thereof may be mixed and used, or the monomer may be present as a salt accompanied by a counter ion. Among others, use of an acidic monomer is preferred, and the acidic monomer is more preferably acrylic acid and/or methacrylic acid.

The total amount of the acidic monomer and basic monomer per 100 parts by mass of all polymerizable monomers constituting the binder resin is usually 0.05 parts by mass or more, preferably 0.5 parts by mass or more, and more preferably 1.0 parts by mass or more, and is usually 10 parts by mass or less, and preferably 5 parts by mass or less.

Other polymerizable monomers include styrenes such as styrene, methylstyrene, chlorostyrene, dichlorostyrene, p-tert-butylstyrene, p-n-butylstyrene and p-n-nonylstyrene, acrylic acid esters such as methyl acrylate, ethyl acrylate, propyl acrylate, n-butyl acrylate, isobutyl acrylate, hydroxyethyl acrylate and 2-ethylhexyl acrylate, methacrylic acid esters such as methyl methacrylate, ethyl methacrylate, propyl methacrylate, n-butyl methacrylate, isobutyl methacrylate, hydroxyethyl methacrylate and 2-ethylhexyl methacrylate, acrylamide, N-propylacrylamide, N,N-dimethylacrylamide, N,N-dipropylacrylamide, N,N-dibutylacrylamide, etc., and one of the polymerizable monomers may be used alone, or a plurality thereof may be used in combination.

Furthermore, in the case of using a crosslinked resin as the binder resin, a polyfunctional monomer having radical polymerizability is used together with the above-described polymerizable monomer, and examples thereof include divinylbenzene, hexanediol diacrylate, ethylene glycol dimethacrylate, diethylene glycol dimethacrylate, diethylene glycol diacrylate, triethylene glycol diacrylate, neopentyl glycol dimethacrylate, neopentyl glycol diacrylate, and diallyl phthalate. It is also possible to use a polymerizable monomer having a reactive group in a pendant group, such as glycidyl methacrylate, methylolacrylamide and acrolein. Among others, a bifunctional polymerizable monomer having radical polymerizability is preferred, and divinylbenzene and hexanediol diacrylate are more preferred. One of these polyfunctional polymerizable monomers may be used alone, or a mixture of a plurality of kinds thereof may be used.

In the case of polymerizing the binder resin by the emulsion polymerization aggregation method, as the emulsifier, a known surfactant may be used, and as the surfactant, one surfactant selected from a cationic surfactant, an anionic surfactant, and a nonionic surfactant may be used, or two or more surfactants selected therefrom may be used in combination.

The cationic surfactant includes, for example, dodecylammonium chloride, dodecylammonium bromide, dodecyltrimethylammonium bromide, dodecylpyridinium chloride, dodecylpyridinium bromide, and hexadecyltrimethylammonium bromide, and the anionic surfactant includes, for example, a fatty acid soap such as sodium stearate and sodium dodecanoate, sodium dodecyl sulfate, sodium dodecylbenzenesulfonate, and sodium lauryl sulfate. The nonionic surfactant includes, for example, polyoxyethylene dodecyl ether, polyoxyethylene hexadecyl ether, polyoxyethylene nonylphenyl ether, polyoxyethylene lauryl ether, polyoxyethylene sorbitan monooleate ether, and monodecanoyl sucrose.

Although the amount of the emulsifier used in a case of producing the toner mother particle by using the emulsion polymerization aggregation method is not particularly limited, it is preferably from 0.1 to 10 parts by mass per 100 parts by mass of the polymerizable monomer. In addition, one member or two or more members of polyvinyl alcohols such as partially or completely saponified polyvinyl alcohol, and cellulose derivatives such as hydroxyethyl cellulose, may be used as a protective colloid in combination with the emulsifier.

The volume average particle diameter of the polymer primary particle obtained by the emulsion polymerization aggregation method is usually 0.02 μm or more, preferably 0.05 μm or more, and particularly preferably 0.1 μm or more, and is usually 3 μm or less, preferably 2 μm or less, and particularly preferably 1 μm or less. If the particle diameter is too small, it may be difficult to control the aggregation speed in the aggregation step, and if the particle diameter is too large, the particle diameter of the toner particle obtained by aggregation may be likely to become large, which makes it difficult to obtain a toner having the intended particle diameter.

In the case of producing the toner mother particle by using the emulsion polymerization aggregation method, a known polymerization initiator may be used, if desired, and one polymerization initiator or a combination of two or more polymerization initiators may be used. For example, a persulfate such as potassium persulfate, sodium persulfate and ammonium persulfate; a redox initiator combining such a persulfate as one component with a reducing agent such as acidic sodium sulfite; a water-soluble polymerization initiator such as hydrogen peroxide, 4,4′-azobiscyanovaleric acid, tert-butyl hydroperoxide and cumene hydroperoxide; a redox initiator combining such a water-soluble polymerization initiator as one component with a reducing agent such as ferrous salt; benzoyl peroxide; and 2,2′-azobisisobutyronitrile are used. This polymerization initiator may be added to the polymerization system at any time, i.e., before, at the same time with or after the addition of monomer, and these addition methods may be combined, if desired.

In the case of producing the toner mother particle by using the emulsion polymerization aggregation method, a known chain transfer agent may be used, if desired. Specific examples thereof include tert-dodecylmercaptan, 2-mercaptoethanol, diisopropylxanthogen, carbon tetrachloride, and trichlorobromomethane. One chain transfer agent may be used alone, or two or more kinds of transfer agents may be used in combination, and the chain transfer agent is used in an amount of 0 to 5% by mass relative to the polymerizable monomer.

In the case of producing the toner mother particle by using the emulsion polymerization aggregation method, a known suspension stabilizer may be used, if desired. Specific examples of the suspension stabilizer include calcium phosphate, magnesium phosphate, calcium hydroxide, and magnesium hydroxide. One member of these may be used, or two or more members thereof may be used in combination. The suspension stabilizer is used usually in an amount of 1 to 10 pans by mass per 100 parts by mass of the polymerizable monomer.

Both of the polymerization initiator and the suspension stabilizer may be added to the polymerization system at any time, i.e., before, at the same time with or after the addition of polymerizable monomer, and these addition methods may be combined.

In addition, a pH adjuster, a polymerization degree controlling agent, a defoaming agent, etc. may be appropriately added to the reaction system.

In order to impart releasability, a wax may be incorporated into the toner of the present invention. The wax used may be any wax as long as it has releasability.

Specifically, the wax includes, for example, an olefin-based wax such as low-molecular-weight polyethylene, low-molecular-weight polypropylene and copolymerized polyethylene; a paraffin wax; an ester-based wax having a long-chain aliphatic group, such as behenyl behenate, montanic acid ester and stearyl stearate; a vegetable wax such as hydrogenated castor oil and carnauba wax; a ketone having a long-chain alkyl group, such as distearyl ketone; a silicone having an alkyl group; a higher fatty acid such as stearic acid; a long-chain aliphatic alcohol such as eicosanol; a carboxylic acid ester or partial ester of a polyhydric alcohol, which is obtained from a polyhydric alcohol such as glycerin or pentaerythritol and a long-chain fatty acid; a higher fatty acid amide such as oleic acid amide and stearic acid amide; and a low-molecular-weight polyester.

Among these waxes, in order to improve the fixing property, the melting point of the wax is usually 30° C. or more, preferably 40° C. or more, and particularly preferably 50° C. or more, and is usually 100° C. or less, preferably 90° C. or less, and particularly preferably 80° C. or less. If the melting point is too low, the wax may be exposed on the surface after the fixing and cause stickiness, and on the other hand, if the melting point is too high, the low-temperature fixing property may be poor.

As for the compound species of wax, a higher fatty acid ester-based wax is preferred. The higher fatty acid ester-based wax is, specifically, preferably an ester of a fatty acid having a carbon number of 15 to 30 with a monohydric to pentahydric alcohol, such as behenyl behenate, stearyl stearate, pentaerythritol stearate and montanic acid glyceride. As for the alcohol component constituting the ester, in the case of a monohydric alcohol, an alcohol having a carbon number of 10 to 30 is preferred, and in the case of a polyhydric alcohol, an alcohol having a carbon number of 3 to 10 is preferred.

The above-described waxes may be used individually or may be mixed and used. The melting point of the wax compound may be appropriately selected according to the fixing temperature at which the toner is fixed.

In the present invention, in the case of incorporating wax, although the amount of wax is not particularly limited but is usually 1 pan by mass or more, preferably 2 parts by mass or more, and particularly preferably 5 parts by mass or more, and is usually 40 parts by mass or less, preferably 35 parts by mass or less, and particularly preferably 30 parts by mass or less, per 100 parts by mass of the toner. If the wax content in the toner is too small, the performance such as high-temperature offset property may not be sufficient, and on the other hand, if the content is too high, the blocking resistance may be insufficient or the wax may leak out from the toner to contaminate the apparatus.

As the coloring agent of the present invention, a known coloring agent can be used at will. Specific examples of the coloring agent include carbon black, Aniline Blue, Phthalocyanine Blue, Phthalocyanine Green, Hansa Yellow, Rhodamine dyes/pigments, Chromium Yellow, quinacridone, Benzidine Yellow, Rose Bengal, triallylmethane dyes, and monoazo, disazo and condensed azo dyes/pigments, and arbitrary known dyes/pigments may be used individually or as a mixture. In the case of a full-color toner, it is preferable to use Benzidine Yellow or a monoazo or condensed azo dye/pigment for yellow, quinacridone or a monoazo dye/pigment for magenta, and Phthalocyanine Blue for cyanine. The coloring agent is preferably used to account for 3 to 20 parts by mass per 100 parts by mass of the polymer primary particle.

Blending of the coloring agent in the emulsion polymerization aggregation method is usually performed in the aggregation step. A dispersion liquid of polymer primary particle and a dispersion liquid of coloring agent particle are mixed to form a mixed dispersion liquid, and the mixed dispersion liquid is then aggregated to form a particle aggregate. The coloring agent is preferably used in the state of being dispersed in water in the presence of an emulsifier, and the volume average particle diameter of the coloring agent particle is usually 0.01 μm or more, and preferably 0.05 μm or more, and is usually 3 μm or less, and preferably 1 μm or less.

In the present invention, a charge control agent may be used, if desired. In the case of using a charge control agent, arbitrary known charge control agents may be used individually or in combination. For example, the positively chargeable charge control agent includes a quaternary ammonium salt, an azine black dye such as nigrosine, processed nigrosine and alkylnigrosine, a processed nigrosine compound, a guanidine compound, a triphenylsulfonium compound, a resin-based charge control agent, an amide group-containing compound, and a basic/electron-donating metal substance, and the negatively chargeable charge control agent includes metal chelates of an aromatic oxycarboxylic acid type and an aromatic dicarboxylic acid type, a monoazo-containing metal complex compound, a metal salt of organic acid, a metal-containing dye, a diphenyl-hydroxy complex compound, an iron-containing azo compound, a charge control agent for emulsion polymerization, various metal complex compounds of oxycarboxylic acid, a calixarene compound, a phenol compound, a resin-based charge control agent, a naphthol compound or a metal salt thereof, a urethane bond-containing compound, and an acidic or electron-withdrawing organic substance.

In the case of using the toner of the present invention as a toner other than black toner in a color toner or full-color toner, a colorless or light-colored charge control agent free from color tone interference with the toner is preferably employed. For example, a quaternary ammonium salt compound is preferred as the positively chargeable charge control agent, and a metal salt or metal complex of salicylic acid or alkylsalicylic acid with zinc, aluminum, etc., a metal salt or metal complex of benzylic acid, an amide compound, a phenol compound, a naphthol compound, a phenolamide compound, and a hydroxynaphthalene compound such as 4,4′-methylenebis[2-[N-(4-chlorophenyl)amide]-3-hydroxynaphthalene] are preferred as the negatively chargeable charge control agent.

In the toner of the present invention, in the case of incorporating a charge control agent into the toner by using an emulsion polymerization aggregation method, the charge control agent may be blended, for example, by a method where the charge control agent is added together with the polymerizable monomer, etc. during emulsion polymerization; is added together with the polymer primary particle, coloring agent, etc. in the aggregation step; or is added after the polymer primary particle, coloring agent, etc. are aggregated to provide a substantially intended particle diameter. Among these, a method where in the aggregation step, the charge control agent is dispersed in water by using a surfactant and added as a dispersion liquid having a volume average particle diameter of 0.01 to 3 μm, is preferred.

In the emulsion polymerization aggregation method, aggregation is usually performed in a tank equipped with a stirring device, and the method therefor includes a method of performing heating, a method of adding an electrolyte, and a combination thereof. In the case of obtaining a particle aggregate of an intended size by aggregating polymer primary particles under stirring, the particle diameter of the particle aggregate is controlled by the balance between the cohesive force of particles to each other and the shearing force by stirring, and the cohesive force can be increased by heating or by the addition of an electrolyte. In the present invention, the electrolyte when performing aggregation by adding an electrolyte may be either an organic salt or an inorganic salt but specifically includes NaCl, KCl, LiCl, Na₂SO₄, K₂SO₄, Li₂SO₄, MgCl₂, CaCl₂, MgSO₄, CaSO₄, ZnSO₄, Al₂(SO₄)₃, Fe₂(SO₄, CH₃COONa, C₆H₅SO₃Na, etc. Among these, an inorganic salt having a divalent or higher polyvalent metal cation is preferred.

In the toner of the present invention, the addition amount of the electrolyte varies depending on the kind of electrolyte, target particle diameter, etc. but is usually 0.05 parts by mass or more, and preferably 0.1 parts by mass or more, per 100 parts by mass of the solid component of the mixed dispersion liquid, and the addition amount is also usually 25 parts by mass or less, preferably 15 parts by mass or less, and particularly preferably 10 parts by mass or less. If the addition amount is too small, the aggregation reaction may proceed slowly, leaving a problem that a fine powder of 1 μm or less remains after the aggregation reaction or the average particle diameter of the obtained particle aggregate does not reach the intended particle diameter. On the other hand, if the addition amount is too large, rapid aggregation may be likely to take place, giving rise to a problem that the particle diameter is difficult to control or a coarse or irregular particle is contained in the obtained aggregate particles. The aggregation temperature when performing the aggregation by adding an electrolyte is usually 20° C. or more, and preferably 30° C. or more, and is usually 70° C. or less, and preferably 60° C. or less.

The aggregation temperature in a case of performing the aggregation only by heating without using an electrolyte is usually (Tg−20°) C or more, and preferably (Tg−10°) C or more, and is usually Tg or less, and preferably (Tg−5°) C or less, wherein Tg is the glass transition temperature of the polymer primary particle.

The time required for aggregation is optimized according to the apparatus shape or the processing scale but in order for the toner particle diameter to reach the intended particle diameter, it is usually preferable to hold the system at the predetermined temperature above for at least 30 minutes or more. As for the temperature rise to reach the predetermined temperature, the temperature may be raised at a constant rate or may be raised in a stepwise manner.

A particle in which a resin particle is attached or fixed, if desired, to the particle aggregate surface after the above-described aggregation treatment may also be formed. When a resin particle having controlled properties is attached or fixed to the particle aggregate surface, the chargeability and heat resistance of the obtained toner may be enhanced, and furthermore, the effect of the present invention can be made more remarkable.

As the resin particle, a resin particle having a glass transition temperature higher than the glass transition temperature of the polymer primary particle is preferably used, since further improvement of the blocking resistance can be realized without impairing the fixing property. The volume average particle diameter of the resin particle is usually 0.02 μm or more, and preferably 0.05 μm or more, and is usually 3 μm or less, and preferably 1.5 μm or less. The usable resin particle includes, for example, a resin particle obtained by emulsion polymerization of the same monomer as the polymerizable monomer used for the polymer primary particle above.

Although the resin particle is usually used in the form of a dispersion liquid prepared by dispersing the resin particle in water or a water-based liquid with use of a surfactant, in the case of adding a charge control agent after the aggregation treatment, it is preferable to add the charge control agent to dispersion liquid containing the particle aggregate and then add the resin particle.

In order to increase the stability of the particle aggregate obtained in the aggregation step, fusion among the aggregate particles is preferably performed in an aging step after the aggregation step. The temperature in the aging step is usually not less than Tg of the polymer primary particle, and preferably not less than a temperature higher by 5° C. than Tg, and usually not more than a temperature higher by 80° C. than Tg, and preferably not more than a temperature higher by 50° C. than Tg. Although the time required for the aging step varies depending on the target toner shape, the system is preferably held for usually from 0.1 to 10 hours, preferably from 1 to 6 hours, after the temperature has reached not less than the glass transition temperature of the polymer primary particle.

In this connection, after the aggregation step, preferably before the aging step or during the aging step, it is preferable to add a surfactant or increase the pH value. As the surfactant used here, one or more members selected from emulsifiers usable at the time of production of the polymer primary particle may be used, but the same emulsifier as that used for the production of the polymer primary particle is preferably used. In the case of adding a surfactant, the addition amount thereof is not particularly limited but is usually 0.1 parts by mass or more, preferably 1 part by mass or more, and more preferably 3 parts by mass or more, and is usually 20 parts by mass or less, preferably 15 parts by mass or less, and more preferably 10 parts by mass or less, per 100 parts by mass of the solid component in the mixed dispersion liquid. When addition of a surfactant or increase of the pH value is effected after the aggregation step but before the completion of aging step, this may make it possible to suppress aggregation, etc. of the particle aggregates aggregated in the aggregation step and prevent formation of a coarse particle after the aging step.

The heat treatment in the aging step brings about fusion/coalescence of polymer primary particles in the aggregate and in turn, the toner particle shape as an aggregate also approaches a sphere. The particle aggregate before the aging step is considered to be a bulk material formed by electrostatic or physical aggregation of polymer primary particles, but after the aging step, the polymer primary particles constituting the particle aggregate are mutually fused, as a result, the toner particle shape can also approach a sphere. According to such an aging step, a toner of various shapes appropriate to the purpose, e.g., a grape type that is a shape formed by aggregation of polymer primary particles, a potato type resulting from the progress of fusion, and a sphere resulting from further progress of fusion, can be produced by controlling the temperature, time, etc. of the aging step.

The obtained particle is subjected to solid-liquid separation by a known method, and the particle is recovered and, if desired, washed and dried, whereby the target toner mother particle can be obtained.

### <External Addition Step>

In the toner of the present invention, the composite particle of a metal oxide and a polymer, the composite oxide particle, and other external additives, which are described above, are attached or fixed to the surface of the toner mother particle, but the method therefor is not particularly limited, and a mixer generally used for the production of a toner may be employed. Specifically, those particles and additives are attached or fixed by stirring and mixing by means of a mixer such as Henschel mixer, V-blender, Loedige mixer, and Q-mixer.

### EXAMPLES

Although the present invention is described more specifically by referring to Examples, the present invention is not limited to the following Examples as long as the gist thereof is observed. In the following examples, “parts” means “parts by mass”, and “%” means “% by mass”.

### <Method for Measuring Volume Median Diameter (Dv50) of Toner Particle>

The volume median diameter was measured by means of Multisizer III (aperture diameter: 100 μm) (hereinafter, simply referred to as “Multisizer”) manufactured by Beckman Coulter, Inc. by using, as a dispersion medium, Isoton II produced by the same company and dispersing the toner particle to afford a dispersoid concentration of 0.03% by mass. The range of particle diameter measured was set to be from 2.00 to 64.00 μm and after this range was discretized into 256 divisions with equal intervals on a logarithmic scale, and the value calculated from their statistical values on the volume basis was taken as the volume median diameter (Dv50).

### <Method for Measuring SF2>

Image analysis of an electron micrograph at a magnification of ×1000 of the toner particle was performed using Luzex-F (manufactured by Nireco Corp.), and the particle projected area (S) and the circumferential length (T) of a particle projection image were determined. SF2 is determined according to the following formula (2):

SF2=(T²/S)×(1/4π)×100 Formula (2):

### <Method for Measuring True Specific Gravity of Inorganic Fine Particle>

The true specific gravity was measured by using a Le Chatelier specific gravity bottle in conformity with JIS-K-0061, 5-2-1. The operation was performed as follows.

(1) About 250 ml of ethyl alcohol was put in a Le Chatelier pycnometer, and the meniscus was adjusted to reach the scale mark position.

(2) The pycnometer was immersed in a constant-temperature water tank and when the liquid temperature became 20.0±0.2° C., the position of the meniscus was accurately read out by the scale marks on the pycnometer (with an accuracy of 0.025 ml).

(3) About 100 g of a sample was weighed, and the mass thereof was designated as W.

(4) The weighed sample was put in the pycnometer, and bubbles were removed.

(5) The pycnometer was immersed in a constant-temperature water tank and when the liquid temperature became 20.0±0.2° C., the position of the meniscus was accurately read out by the scale marks on the pycnometer (with an accuracy of 0.025 ml).

(6) The true specific gravity was calculated according to the following formulae:

D=W/(L2−L1)

S=D/0.9982

In the formulae, D is the density (20° C.) (g/cm³) of sample, S is the true specific gravity (20° C.) of sample, W is the apparent mass (g) of sample, L1 is the reading of meniscus (20° C.) (ml) before the sample is put in the pycnometer, L2 is the reading of meniscus (20° C.) (ml) after the sample is put in the pycnometer, and 0.9982 is the density (g/cm³) of water at 20° C.

### <Method for Measuring Metal Oxide/Polymer Weight Ratio>

The ratio of the weight of sample when from 10 to 15 mg of a polymer externally added with a metal oxide was heated at 20° C./min to 800° C. from room temperature in an air flow at about 300 mL/min by using TG-DTA 220U of Seiko Instruments Inc. and held at 800° C. for 5 minutes, to the initial weight was taken as the ash content A (%), and the weight ratio was calculated according to (100−A)/A.

### <Method for Detecting Polymer Constituent Substance in Metal Oxide/Polymer Composite>

As to the conditions of pyrolysis gas chromatography-mass spectrometry, about 0.7 mg of a metal oxide/polymer composite was pyrolyzed at 550° C. in a helium flow by means of a pyrolysis apparatus PY-2020iD of Frontier Laboratories Ltd., and the generated gas was introduced into GCMS-QP2010 of Shimadzu Corporation and analyzed. Using Ultra ALLOY UA-5 of 30 m×0.25 mm×0.25 μm of Frontier Laboratories Ltd. as the column, the constituent substances can be detected by obtaining a total ion chromatogram under the settings of a column flow rate of helium of 1 mL/min, a split ratio of 100, a sample inlet temperature of 300° C., an oven program of holding at 40° C. for 1 minute and then heating at 10° C./min to 300° C., a detector interface temperature of 340° C., an ion source temperature of 260° C., a detector voltage of 1.0 kV, and an m/z scanning range of quadrupole mass spectrometer of 30 to 400.

### [Production of Mother Particle]

### <Preparation of Wax-Long-Chain Polymerizable Monomer Dispersion Liquid A1>

After heating 27 Parts of paraffin wax (HNP-9, produced by Nippon Seiro Co., Ltd.), 2.8 parts of stearyl acrylate (produced by Tokyo Chemical Industry Co., Ltd.), 1.9 parts of an aqueous 20% sodium dodecylbenzenesulfonate solution (Neogen S20D, produced by DKS Co. Ltd.; hereinafter simply referred to as “aqueous 20% DBS solution”), and 68.3 parts of desalted water to 90° C., stirring was carried out for 10 minutes with a homomixer (Model Mark IIf, manufactured by Tokusbu Kika Kogyo Co., Ltd.). Subsequently, the resulting dispersion liquid was heated to 90° C., and circulation emulsification was initiated under a pressure condition of 25 MPa by means of a homogenizer (Model 15-M-8PA, manufactured by Gaulin). With measuring the particle diameter with Nanotrac, the dispersion was continued until reaching a volume average particle diameter (MV) of 250 nm to make Wax•Long-Chain Polymerizable Monomer Dispersion Liquid A1 (solid content concentration of emulsion=30.2%).

### <Preparation of Polymer Primary Particle Dispersion Liquid A1>

Into a reaction vessel equipped with a stirring device (three blades), a heating/cooling device, a concentrating device, and a device for charging each raw material-adjuvant, 35.6 Parts of Wax•Long-Chain Polymerizable Monomer Dispersion Liquid A1 and 259 parts of desalted water were charged, and heated to 90° C. with stirring in a nitrogen flow.

Thereafter, with continuing stirring, a mixture of the following monomers-aqueous emulsifier solution was added over first 5 hours of the polymerization. Assuming that the time when initiating the dropwise addition of the mixture of monomers-aqueous emulsifier solution is polymerization initiation, the aqueous initiator solution shown below was added over 4.5 hours after 30 minutes from the polymerization initiation, and the additional aqueous initiator solution shown below was added over 2 hours after 5 hours from the polymerization initiation. With continuing stirring, the system was further held for one hour by keeping the internal temperature of 90° C.

[Monomers]

| | |
|---|---|
| Styrene | 76.8 parts |
| Butyl acrylate | 23.2 parts |
| Acrylic acid | 1.5 parts |
| Trichlorobromomethane | 1.0 part |
| Hexanediol diacrylate | 0.7 parts |

[Aqueous Emulsifier Solution]

| | |
|---|---|
| Aqueous 20% DBS solution | 1.0 part |
| Desalted water | 67.1 parts |

[Aqueous Initiator Solution]

| | |
|---|---|
| Aqueous 8% hydrogen peroxide solution | 15.5 parts |
| Aqueous 8% L(+)-ascorbic acid solution | 15.5 parts |

[Additional Aqueous Initiator Solution]

| | |
|---|---|
| Aqueous 8% L(+)-ascorbic acid solution | 14.2 parts |

After the completion of polymerization reaction, the reaction solution was cooled to obtain milky-white Polymer Primary Particle Dispersion Liquid A1. The volume average diameter (MV) determined by measuring the dispersion liquid by means of Nanotrac was 280 nm, and the solid content concentration was 21.1%.

<Production of Mother Particle A>

| | |
|---|---|
| Polymer Primary Particle Dispersion Liquid A1 | 90 parts as solid |
| | content |
| Polymer Primary Particle Dispersion Liquid A1 | 10 parts as solid |
| | content (added later) |
| Cyan pigment dispersion liquid (EP750 produced by | 4.4 parts as coloring |
| Dainichiseika Color & Chemicals Mfg. Co., Ltd.) | agent solid content |
| Aqueous 20% DBS solution | 0.1 parts as solid |
| | content |

The mother particle was produced using respective components above by the following procedure.

Polymer Primary Particle Dispersion Liquid A1 and Aqueous 20% DBS Solution were charged into a mixer equipped with a stirring device (double helical blades), a heating/cooling device, a concentrating device, and a device for charging each raw material-adjuvant, and uniformly mixed at an internal temperature of 10° C. for 3 minutes. Subsequently, with continuing the stirring at an internal temperature of 10° C., an aqueous 5% ferrous sulfate solution in an amount of 0.52 parts as FeSO₄.7H₂O was added over 4 minutes; the cyan pigment dispersion liquid was then added over 4 minutes; and these were uniformly mixed at an internal temperature of 10° C. Furthermore, under the same conditions, an aqueous 0.5% aluminum sulfate solution was added dropwise (0.10 parts as solid content relative to the resin solid content). Thereafter, the temperature was raised to an internal temperature of 44° C. over 49 minutes and further raised to 50° C. over 200 minutes. Here, the volume median diameter was measured by means of Multisizer and found to be 5.3 μm. Furthermore, Polymer Primary Particle Dispersion Liquid A1 (later added portion) was added over 8 minutes and held for 30 minutes, and the aqueous 20% DBS solution (6 parts as solid content) was added over 8 minutes. The temperature was then raised to 95° C. over 88 minutes and held for 94 minutes.

Thereafter, the solution was cooled to 30° C. over 20 minutes, and the obtained slurry was withdrawn and subjected to suction filtration by an aspirator by using filter paper of 5-Shu C (No5C, manufactured by Toyo Roshi Kaisha, Ltd.). The cake remained on the filter paper was transferred to a stainless steel container equipped with a stirrer (propeller blades), uniformly dispersed by adding ion-exchanged water having an electrical conductivity of 1 μS/cm and then continuously stirred for 30 minutes.

The dispersion was again subjected to suction filtration by an aspirator by using filter paper of 5-Shu C (No5C, manufactured by Toyo Roshi Kaisha, Ltd.), and the solid material remained on the filter paper was again transferred to a container being equipped with a stirrer (propeller blades) and containing ion-exchanged water having an electrical conductivity of 1 μS/cm; uniformly dispersed by stirring; and then continuously stirred for 30 minutes. This process was repeated five times, as a result, the electrical conductivity of the filtrate became 2 μS/cm.

The cake obtained here was spread in a stainless steel vat to give a height of 20 mm and dried for 48 hours in an air-circulating dryer set at 40° C. to obtain Toner Mother Particle A. The volume median diameter of Toner Mother Particle A was 5.6 μm, and the average circularity was 0.975.

### <Preparation of Polymer Primary Particle Dispersion Liquid B1 (for Shell)>

Into a reaction vessel equipped with a stirring device (three blades), a heating/cooling device, a concentrating device, and a device for charging each raw material-adjuvant, 2.0 Parts of the aqueous 20% DBS solution and 355 parts of desalted water were charged, and heated to 90° C. with stirring in a nitrogen flow. When the temperature reached 90° C., the “aqueous initiator solution for first charge” shown below was added.

Thereafter, with continuing stirring of the solution above, a mixture of the following “polymerizable monomers, etc.” and “aqueous emulsifier solution” was added over 5 hours. Assuming that the time when initiating the dropwise addition of the mixture is “polymerization initiation”, the “aqueous initiator solution” shown below was added over 6.0 hours after 0 minutes from the polymerization initiation, and with continuing stirring, the system was further held for one hour by keeping the internal temperature of 90° C.

[Polymerizable Monomers, etc.]

| | |
|---|---|
| Styrene | 100.0 parts |
| Acrylic acid | 0.5 parts |
| Trichlorobromomethane | 0.5 parts |

[Aqueous Emulsifier Solution]

| | |
|---|---|
| Aqueous 20% DBS solution | 1.0 part |
| Desalted water | 42.1 parts |

[Aqueous Initiator Solution for First Charge]

| | |
|---|---|
| Aqueous 8% by mass of hydrogen peroxide solution | 3.2 parts |
| Aqueous 8% by mass of L(+)-ascorbic acid solution | 3.2 parts |

[Aqueous Initiator Solution]

| | |
|---|---|
| Aqueous 8% by mass of hydrogen peroxide solution | 18.9 parts |
| Aqueous 8% by mass of L(+)-ascorbic acid solution | 18.9 parts |

After the completion of polymerization reaction, the reaction solution was cooled to obtain milky-white Polymer Primary Particle Dispersion Liquid B1. The volume average diameter (Mv) determined by measuring the dispersion liquid by means of Nanotrac was 156 nm, and the solid content concentration was 19.6% by mass.

<Production of Mother Particle B>

| | |
|---|---|
| Polymer Primary Particle Dispersion Liquid A1 | 90 parts as solid |
| (Dispersion Liquid A1: 318.1 kg/solid content: | content |
| 71.2 kg, for core) | |
| Polymer Primary Particle Dispersion Liquid B1 | 10 parts as solid |
| (Dispersion Liquid B1: 40.4 kg/solid content: | content |
| 7.9 kg, for shell) | |
| Cyan pigment dispersion liquid (EP750 produced by | 4.4 parts as coloring |
| Dainichiseika Color & Chemicals Mfg. Co., Ltd.) | agent solid content |
| Aqueous 20% DBS solution | 0.1 parts as solid |
| | content in rounding |
| | step |

Polymer Primary Particle Dispersion Liquid A1 was charged into a mixer (volume: 1,000 L, inner diameter: 850 mm) equipped with a stirring device (double helical blades), a heating/cooling device, and a device for charging each raw material-adjuvant, and 0.05 parts of the aqueous 20% DBS solution was added and uniformly mixed for 10 minutes at an internal temperature of 10° C. Subsequently, with stirring at 101 rpm at an internal temperature of 10° C., an aqueous 5% by mass potassium sulfate solution in an amount of 0.12 parts as K₂SO₄ was continuously added over one minute, and the cyan pigment dispersion liquid was continuous added over 5 minutes and uniformly mixed at an internal temperature of 10° C.

Subsequently, 0.2 parts of an aqueous 0.5% by mass aluminum sulfate solution was continuously added over 30 minutes, 0.2 parts of desalted water was further added over 30 minutes, and with keeping the rotational speed of 101 rpm, the internal temperature was raised to 54.0° C. over 90 minutes. After 30 minutes, the temperature was raised by 1.0° C. and held at 55.0° C., and the particle was grown to 6.00 μm by measuring the volume median diameter by means of Multisizer.

Thereafter, with keeping the internal temperature of 55.0° C. and the rotational speed of 101 rpm, Polymer Primary Particle Dispersion Liquid B1 was continuously added over 15 minutes and held for 60 minutes. At this time, Dv50 of the particle was 6.15 μm. Subsequently, with the same rotation speed, the temperature was raised to 90° C. with adding a mixed solution of the aqueous 20% DBS solution (6 parts as solid content) and 0.04 parts of water over 30 minutes, and further raised to 101.5° C. Heating and stirring were continued under these conditions until the average circularity became 0.974 over 1.5 hours. The solution was then cooled to 20° C. over 50 minutes to obtain a slurry of the toner mother particle. At this time, the volume median diameter of the particle was 6.36 μm, the number median diameter was 5.94 μm, the distribution (volume median diameter)/(number median diameter) was 1.071, and the average circularity was 0.978.

The whole amount of the obtained slurry was subjected to a filtration treatment by means of a wet electromagnetic sieve shaker (AS200, manufactured by Retsch) equipped with a sieve having an opening of 24 μm for the purpose of removing coarse particles and then once stored in a tank with a stirring device. Subsequently, the slurry was supplied to a horizontal centrifugal separator (Model HZ40Si, Mitsubishi Kakoki Kaisha, Ltd.) having mounted therein a filter cloth (polyester TR815C, Nakao Filter Media Corp.; thickness, 0.3 mm; air permeability: 48 (cc/cm²/min)), and centrifugal dehydration washing was performed under the condition of an acceleration of 800 G. When ion-exchanged water having an electrical conductivity of 1 μS/cm was added thereto in an amount of about 50 times of the solid content of the slurry at a rate not allowing the water to overflow the rim, the electrical conductivity of the filtrate became 2 μS/cm. Finally, water was fully drained, and the cake was recovered with a scraper.

The cake obtained here was spread in a stainless steel vat to give a height of 20 mm and dried for 48 hours in an air-circulating dryer set at 40° C. to obtain Toner Mother Particle B.

### Example 1

### <Production of Toner A>

To Toner Mother Particle A (100 parts), 4 parts of a polymer/silica composite particle (ATLAS 100, produced by Cabot Corporation, silica/polymer ratio=70/30, true specific gravity=1.7 g/cm³, containing octahydropentalene), 0.5 parts of a composite oxide particle of titania and silica (STX501, produced by Nippon Aerosil Co., Ltd.), and 0.4 parts of small-diameter silica (RY200L, produced by Nippon Aerosil Co., Ltd.) were added, stirred-mixed for 15 minutes by means of a Henschel mixer at 3,000 rpm, and sieved to obtain Toner A. SF2 of Toner A was 110.

### Example 2

### <Production of Toner B>

Toner B was obtained in the same manner as in Example 1 except that in Example 1, the composite oxide particle of titania and silica was changed to STX801 (produced by Nippon Aerosil Co., Ltd.). SF2 of Toner B was 109.

### Example 3

### <Production of Toner A1>

Toner A1 was obtained in the same manner as in Example 1 except that in Example 1, the amount of the polymer/silica composite particle (ATLAS 100, produced by Cabot Corporation) was changed to 2 parts. SF2 of Toner A1 was 110.

### Example 4

### <Production of Toner A2>

Toner A2 was obtained in the same manner as in Example 3 except that in Example 3, the amount of the composite oxide particle of titania and silica (STX501, produced by Nippon Aerosil Co., Ltd.) was changed to 0.45 parts. SF2 of Toner A2 was 110.

### Example 5

### <Production of Toner A3>

Toner A3 was obtained in the same manner as in Example 1 except that in Example 1, the amount of the polymer/silica composite particle (ATLAS 100, produced by Cabot Corporation) was changed to 3 parts and the amount of the composite oxide particle of titania and silica (STX501, produced by Nippon Aerosil Co., Ltd.) was changed to 0.1 parts. SF2 of Toner A3 was 110.

### Example 6

### <Production of Toner A4>

Toner A4 was obtained in the same manner as in Example 5 except that in Example 5, the amount of the composite oxide particle of titania and silica (STX501, produced by Nippon Aerosil Co., Ltd.) was changed to 0.8 parts. SF2 of Toner A4 was 110.

### Example 7

### <Production of Toner A5>

Toner A5 was obtained in the same manner as in Example 5 except that in Example 5, the amount of the composite oxide particle of titania and silica (STX501, produced by Nippon Aerosil Co., Ltd.) was changed to 0.5 parts. SF2 of Toner A5 was 110.

### Example 8

### <Production of Toner X>

Toner X was obtained in the same manner as in Example 7 except that in Example 7, Toner Mother particle A was changed to Toner Mother Particle B. SF2 of Toner X was 1.06.

### Comparative Example 1

### <Production of Toner C>

Toner C was obtained in the same manner as in Example 1 except that in Example 1, silica (X24-9600A, produced by Shin-Etsu Chemical Co., Ltd.) was used in place of the polymer/metal oxide composite particle and titania (NKT90, produced by Nippon Aerosil Co., Ltd.) was used in place of the composite oxide particle of titania and silica. SF2 of Toner C was 110.

### Comparative Example 2

### <Production of Toner D>

Toner D was obtained in the same manner as in Example 1 except that in Example 1, titania (NKT90, produced by Nippon Aerosil Co., Ltd.) was used in place of the composite oxide particle of titania and silica. SF2 of Toner D was 110.

### Comparative Example 3

### <Production of Toner D1>

Toner D1 was obtained in the same manner as in Comparative Example 1 except that in Comparative Example 1, a composite oxide particle of titania and silica (STX501, produced by Nippon Aerosil Co., Ltd.) was used in place of titania (NKT90, produced by Nippon Aerosil Co., Ltd.). SF2 of Toner D1 was 110.

### <Evaluation Method of Toner by Actual Printing Test>

In the actual printing test, a full-color printer using a nonmagnetic two-component contact developing system and an organic photoreceptor (OPC) and employing roller charging, a speed of 30 ppm, a tandem system, a heat fixing system and a blade drum cleaning system was used.

After charging the toner for evaluation into a replenishing toner hopper in an environment of 25° C.•50%, a chart having a printing ratio of 5% was printed on a total of 2,000 sheets. In this printing on 2,000 sheets, a solid image was printed every printing on 500 sheets, and the presence or absence of an image defect attributable to carrier attraction or chargeability, such as white spot and streak, was confirmed with an eye. The judgment standards are as follows.

### [Judgment Standards]

A: No image defect.

C: An image defect is observed and poses a problem in practical use.

### <Fogging on Printed Matter>

After the continuous actual printing on 2,000 sheets above, the printer was left standing overnight, continuous printing was again performed on 1,000) sheets next morning, and fogging on the printed matter was evaluated as follows. That is, the whiteness difference A of standard paper (brightness: 92, paper thickness: 75 g/m², size: A4) between before and after printing was calculated by means of SE-6000 (standard light/viewing angle) manufactured by Nippon Denshoku Industries Co., Ltd. The value of paper fogging was the average of two sheets.

The judgment standards are as follows.

### [Judgment Standards]

A: Paper fogging of less than 1.6

C: Paper fogging of 1.6 or more

### <Evaluation of Image Density>

A solid image was printed simultaneously with the measurement of fogging and measured for the image density (ID: Image Density). In the measurement of image density, a spectrodensitometer Six) Series (manufactured by X-Rite Inc.) was used, and the measurement was conducted at a viewing angle of 10° under the observation condition of F2. The judgment standards are as follows.

### [Judgment Standards]

A: ΔID is 0.90 or more.

B: ΔID is from 0.70 to less than 0.90.

C: ΔID is less than 0.70.

The evaluation results as to Examples 1 to 8 and Comparative Examples 1 to 3 are shown in Table-1 below.

TABLE 1

| | | | | | | | | | Compar- | Compar- | Compar- |
|---|---|---|---|---|---|---|---|---|---|---|---|
| | | | | | | | | | ative | ative | ative |
| | Example | Example | Example | Example | Example | Example | Example | Example | Example | Example | Example |
| No. | 1 | 2 | 3 | 4 | 5 | 6 | 7 | 8 | 1 | 2 | 3 |
| Toner | A | B | A1 | A2 | A3 | A4 | A5 | X | C | D | D1 |
| Mother | 100 parts | 100 parts | 100 parts | 100 parts | 100 parts | 100 parts | 100 parts | — | 100 parts | 100 parts | 100 parts |
| Particle A | | | | | | | | | | | |
| Mother | — | — | — | — | — | — | — | 100 parts | — | — | — |
| Particle B | | | | | | | | | | | |
| ATLAS100 | 4 parts | 4 parts | 2 parts | 2 parts | 3 parts | 3 parts | 3 parts | 3 parts | — | 4 parts | |
| X24-9600A | — | — | — | — | — | — | — | — | 4 parts | — | 4 parts |
| NKT90 | — | — | — | — | — | — | — | — | 0.5 parts | 0.5 parts | — |
| STX501 | 0.5 parts | — | 0.5 parts | 0.45 parts | 0.1 parts | 0.8 parts | 0.5 parts | 0.5 parts | — | — | 0.5 parts |
| STX801 | — | 0.5 parts | — | — | — | — | — | — | — | — | — |
| RY200L | 0.4 parts | 0.4 parts | 0.4 parts | 0.4 parts | 0.4 parts | 0.4 parts | 0.4 parts | 0.4 parts | 0.4 parts | 0.4 parts | 0.4 parts |
| SF2 | 110 | 109 | 110 | 110 | 110 | 110 | 110 | 1.06 | 110 | 110 | 110 |
| Presence or | A | A | A | A | A | A | A | A | C | A | C |
| absence of | | | | | | | | | | | |
| image defect | | | | | | | | | | | |
| Fogging | A(0.91) | A(1.32) | A(0.17) | A(0.24) | A(0.28) | A(0.13) | A(0.19) | A(0.18) | A(0.34) | A(1.87) | A(0.08) |
| Image | A(0.94) | A(0.98) | A(0.93) | A(0.91) | A(0.94) | A(0.90) | A(0.93) | A(0.96) | A(0.94) | A(1.07) | A(0.89) |
| density | | | | | | | | | | | |

While the invention has been described in detail and with reference to specific embodiments thereof, it will be apparent to one skilled in the art that various changes and modifications can be made therein without departing from the spirit and scope of the invention. This application is based on Japanese Patent Application (Patent Application No. 2015-061264) filed on Mar. 24, 2015, the contents of which are incorporated herein by way of reference.

1. A toner for developing an electrostatic charge image comprising a toner mother particle containing a binder resin and a coloring agent, and an external additive, wherein:
the external additive contains, as a first external additive, a metal oxide-polymer composite particle containing a metal oxide binding to a polymer and, as a second external additive, a composite oxide particle containing titania and silica.

2. The toner for developing an electrostatic charge image according to claim 1, wherein SF2 represented by the following formula (2) of the toner is from 100 to 120:
SF2=(T²/S)×(1/4π)×100 Formula (2):
wherein S represents the particle projected area, and T represents the circumferential length of a particle projection image.

3. The toner for developing an electrostatic charge image according to claim 1, wherein the metal oxide of the metal oxide-polymer composite particle is silicon oxide.

4. The toner for developing an electrostatic charge image according to claim 1, wherein the value A=(weight of metal oxide/weight of polymer)/(true specific gravity of metal oxide: g/cm³) as determined by ash measurement of the metal oxide-polymer composite particle in a calorimeter measuring device is from 0.5 to 2.5.

5. The toner for developing an electrostatic charge image according to claim 1, wherein a compound having a skeleton represented by the following formula (1) is detected by pyrolysis gas chromatography-mass spectrometry on the metal oxide-polymer composite particle: 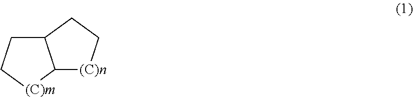
wherein each of m and n independently represents an integer of 1 to 3.
